(19) United States
(12) Patent Application Publication
(10) Pub. No.: US 2010/0076943 A1
(43) Pub. Date: Mar. 25, 2010

(54) Foreign-Language Learning Method Utilizing An Original Language to Review Corresponding Foreign Languages and Foreign-Language Learning Database System Thereof

(76) Inventors: Shing-Lung Chen, Kaoshiung (TW); Chen-Sung Chang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/429,301

(22) Filed: Apr. 24, 2009

(30) Foreign Application Priority Data
Sep. 11, 2008 (TW) 097134887

(51) Int. Cl. G06F 17/30

(52) U.S. Cl. 707/705; 707/E17.015

(57) ABSTRACT

A foreign-language learning method includes: providing first language sentences and second language sentences in a database, each first language sentence linking at least one second language sentence; analyzing and retrieving first-language-sentence structures from the first language sentences and second-language-sentence structures from the second language sentences, each first-language-sentence structure linking the corresponding first language sentence and each second-language-sentence structure linking the corresponding second language sentence; inputting a first-language or second-language query sentence into the database; retrieving a sentence structure from the query sentence; comparing the sentence structure of the query sentence with the first-language-sentence or second-language-sentence structures so as to generate matched sentences; reviewing the matched first language sentences in the first language for determining the desired second language sentence, or reviewing the matched second language sentences in the second language for determining the desired first language sentence.

### BACKGROUND OF THE INVENTION

1. Field of the Invention

The present invention relates to a foreign-language learning method utilizing an original language to preview or review texts of corresponding foreign languages and a foreign-language learning database system thereof for user interaction in translation practicing. More particularly, the present invention relates to the method and the database system utilizing a source language to preview or review texts of corresponding target languages.

2. Description of the Related Art

With the coming of the age of globalization, there has come an increased need for translating web text from one language into another language. There are two major problems in studying professional knowledge in different foreign languages. The first problem is how to skillfully translate foreign (source) languages into a target language, and the next problem is how to interpret and digest the technical information contained in the professional knowledge.

U.S. Patent Application Publication No. US 2006/0271352, entitled “Integrated Native Language Translator,” discloses that a method and apparatus provides for performing language translation by obtaining a selection of a language preference for presentation of text and/or speech on an electronic device. Integrated native language browsing allows a user to identify a target language for presentation of data. A browser, plug-in, or other application, residing locally or on a server, such as an edge server or proxy server, may review received data for language content. When the language of the received data is substantially a foreign language, a translation to the target language may be automatically invoked. Thus, the user does not have to explicitly cut and paste text into a translator, but rather may have an entire page presented in the target language in its original context. After translated, the web page or other data may be presented in the native language.

However, there is a need of learning or practicing the skill of human translation from the source language to the target language while studying professional knowledge or reviewing the web page. Conventionally, such a type of learning or practicing the skill of translation exists some drawbacks as follows:
1. Users cannot rapidly select an appropriate sentence pattern from the group of sentence patterns learned in the past.
2. Users cannot know or estimate the correctness of the meaning or sentence pattern for his expression in practicing or studying translation.

Currently, there are three typical translation tools, widely used, to assist human translators including: 1 translation machines (known as electronic dictionary); 2. machine translation software; and 3. dictionary books. However, such translation tools exist some drawbacks during use.

In fact, the conventional translation machine, machine translation software and dictionary book cannot offer a good effect in learning translation. However, a number of limits exist for using the conventional translation machine, machine translation software and dictionary book as follows:
1. Many of vocabularies provided in the conventional translation machine, machine translation software and dictionary book couldn't generate a complete sentence or sentence pattern.
2. The examples of sentence patterns generated from the translation machine, machine translation software and dictionary book couldn't reflect the exact meaning or approximate meaning expected by the user even though they are grammatically correct.
3. The examples of vocabularies and sentence patterns provided in the translation machine, machine translation software and dictionary book are few, and the number of vocabularies and sentence patterns are limited and inadequate for professional translation use.

In general, machine translation, sometimes referred to by the abbreviation MT, is conducted by the use of computer software to translate text or speech from one natural language to another. In fact, a practicing method by using the machine translation software has several drawbacks. For instant, the primary problem with such machine translation software is a low correctness of the translated language (i.e. target language).

Currently, the major approaches to the machine translation are a systematical grammar-based method and a statistical method rather than a rule-based method or a transfer-based method. Regarding the use of the rule-based or transfer-based method, such a method requires extensive lexicons with morphological, syntactic, and semantic information. Another problem with the use of the grammar-based method is due to the fact that the grammar methods need a skilled linguist to carefully design the grammar. Another problem with the use of the statistical method is due to the fact that the statistical methods need a large multilingual corpus of data to work. Accordingly, in these methods the structures of translated sentences are limited in those of the source languages.

Such methods are difficult to translate the languages in completely correct or fluent language grammar. As a result, the translated language generated by the machine translation is completely vague and fails to express the exact meaning of the source language. Hence, there is a need of revising the translated language by human translators but they are expensive and lengthen total translation time. An additional problem with human translation is the small availability of qualified individuals to perform such tasks.

U.S. Pat. No. 4,685,060, entitled “Method of Translation between Languages with Information of Original Language Incorporated with Translated Language Text,” discloses a method of translating a first language into a second language and using identification numbers corresponding to words/idioms of the first language to generate the second language text, the contents of which are hereby incorporated by reference herein.

In the most sense, individual beginners (human translators without specialized skill) can manually conduct translation performed with the method of using translation textbooks or teaching materials which will require labor-intensive human translation practice, and result in a low efficiency in translation practicing.

As is described in greater detail below, the present invention intends to provide a foreign-language learning method utilizing an original language (i.e. source language) to preview or review texts of corresponding foreign languages (i.e. target language) for user interaction in translation practicing and a foreign-language learning database system thereof in such a way as to mitigate and overcome the above problem.

### SUMMARY OF THE INVENTION

The primary objective of this invention is to provide a foreign-language learning method and a database system thereof utilizing an original language to preview or review corresponding foreign languages for user interaction in translation practicing. Accordingly, users can preview and select the translated texts displayed in the original language prior to convert an input text into target language.

The foreign-language learning method utilizing an original language to review texts of corresponding foreign languages in accordance with an aspect of the present invention includes the steps of:

providing first language sentences and second language sentences in a database, each of the first language sentences linking at least one second language sentence;

analyzing and retrieving first-language sentence structures from the first language sentences and second-language sentence structures from the second language sentences, each of the first-language sentence structures linking the corresponding first language sentence and each of the second-language sentence structures linking the corresponding second language sentence;

inputting a first-language or second-language query sentence (source language) into the database;

retrieving a sentence structure from the first-language or second-language query sentence;

comparing the sentence structure of the first-language or second-language query sentence with the first-language sentence or second-language sentence structures so as to generate at least one or a set of matched sentences, and displaying the matched first or second language sentences; and

reviewing the matched first language sentences (source language) displayed in the first language for determining the desired second language sentence (target language), or reviewing the matched second language sentences (source language) displayed in the second language for determining the desired first language sentence (target language).

The foreign-language learning database system utilizing an original language to review texts of corresponding foreign languages in accordance with an aspect of the present invention includes:

a plurality of first language sentences grouped in a first predetermined area;

a plurality of first-language sentence structures retrieved from the first language sentences and classified according to their structures, each of the first-language sentence structures linking the corresponding first language sentence;

a plurality of second language sentences grouped in a second predetermined area, each of the first language sentences linking at least one of the second language sentences; and

a plurality of second-language sentence structures retrieved from the second language sentences and classified according to their structures, each of the second-language sentence structures linking the corresponding second language sentence;

wherein when a first-language or second-language query sentence is input into the database, a sentence structure is retrieved from the first-language or second-language query sentence to compare with the first-language sentence or second-language sentence structures so as to generate at least one or a set of matched sentences; and wherein the matched first language sentences are displayed in the first language and are reviewed in the first language in determining at least one of the desired second language sentences, or the matched second language sentences are displayed in the second language and are reviewed in the second language in determining at least one of the desired first language sentences.

In a separate aspect of the present invention, the first language sentences are performed in Chinese.

In a further separate aspect of the present invention, the second language sentences are performed in English.

In a yet further separate aspect of the present invention, the matched sentences are provided with a matching degree.

In a yet further separate aspect of the present invention, third language sentences are provided in the database and each of the first language sentences links at least one of the corresponding third language sentences.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a foreign-language learning database system utilizing an original language to review corresponding foreign languages in accordance with a first embodiment of the present invention.

FIG. 2 is a flow chart of an establishing method of the foreign-language learning database system in accordance with a preferred embodiment of the present invention.

FIG. 3 is a block diagram of the foreign-language learning database system in accordance with a second embodiment of the present invention.

### DETAILED DESCRIPTION OF THE INVENTION

It is noted that a foreign-language learning method and a foreign-language learning database system thereof utilizing an original language to preview or review texts of corresponding foreign languages in accordance with the present invention can be implemented on a variety of different computing equipment, including stand-alone personal computers, networked computers, laptop computers, workstations, or the like; and an establishing method for the system of the present invention can be formed with computer-executable process steps.

Users without specialized translation skill can use the foreign-language learning database system in accordance with the present invention to perform language translation from a source language (i.e. native language) to a target language, and to view the translated text in their native languages or preferred languages. In translation practicing, the foreign-language learning database system in accordance with the present invention can compare input texts in native language (e.g. in Chinese) with native language sentences stored in the database so as to generate matched sentences in the native language. Users can review the matched sentences in their native languages or preferred languages without the need of considering the user's translation skill affecting the accuracy of translation results.

In this circumstance, users can review the accuracy of the matched sentences in their native language or skilled language, and can judge the meaning similarity between the input texts and the matched sentences. Accordingly, the user needs not to use an unskilled language in reviewing the translated texts.

The foreign-language learning database system in accordance with the present invention can be functioned to provide sentence-to-sentence translation rather than word-to-word translation. In translation practicing, users can also review the accuracy of the original meaning in the sentence-to-sentence translation by using their native languages or preferred languages.

The foreign-language learning method in accordance with a preferred embodiment of the present invention includes the steps of:

providing first language sentences (i.e. native language) and second language sentences (i.e. foreign language) in a database, each of the first language sentences linking at least one second language sentence such that the second language sentences can be searched by the first language sentences, and vice versa;

analyzing and retrieving first-language sentence structures from the first language sentences and second-language sentence structures from the second language sentences, each of the first-language sentence structures linking the corresponding first language sentence and each of the second-language sentence structures linking the corresponding second language sentence such that each of the first-language sentence structures links the second-language sentence structure, and vice versa;

inputting a first-language or second-language query sentence into the database via a computer interface such that the first-language or second-language query sentence is considered as a computer-readable source language;

retrieving a sentence structure from the first-language or second-language query sentence;

comparing the sentence structure of the first-language or second-language query sentence with the first-language sentence or second-language sentence structures so as to generate at least one or a set of matched sentences, and displaying the matched first or second language sentences; and

reviewing the matched first language sentences (source language) displayed in the first language for determining the desired second language sentence (target language), or reviewing the matched second language sentences (source language) displayed in the second language for determining the desired first language sentence (target language).

The foreign-language learning system in accordance with a preferred embodiment of the present invention includes a plurality of first language sentences, a plurality of first-language sentence structures, a plurality of second language sentences and a plurality of second-language sentence structures. Each of the first language sentences links at least one of the second language sentences. The first language sentences and the second language sentences are grouped in a first predetermined area and a second predetermined area of the database, respectively. The first-language sentence structures are retrieved from the first language sentences and classified according to their structures, and each of the first-language sentence structures links the corresponding first language sentence. Correspondingly, the second-language sentence structures are retrieved from the second language sentences and classified according to their structures, and each of the second-language sentence structures links the corresponding second language sentence.

In translation practicing, a first-language or second-language query sentence is input into the database via a computer interface so that a sentence structure is retrieved from the first-language or second-language query sentence to automatically compare with the first-language sentence or second-language sentence structures. After compared, at least one or a set of matched sentences may be successfully generated. In a preferred embodiment, the matched sentences are displayed in the original language on a display device and are reviewed in the original language in determining at least one of the desired second or first language sentences via an interactive interface. For example, the matched first language sentences are displayed in the first language and are reviewed in the first language in determining at least one of the desired second language sentences; or, the matched second language sentences are displayed in the second language and are reviewed in the second language in determining at least one of the desired first language sentences.

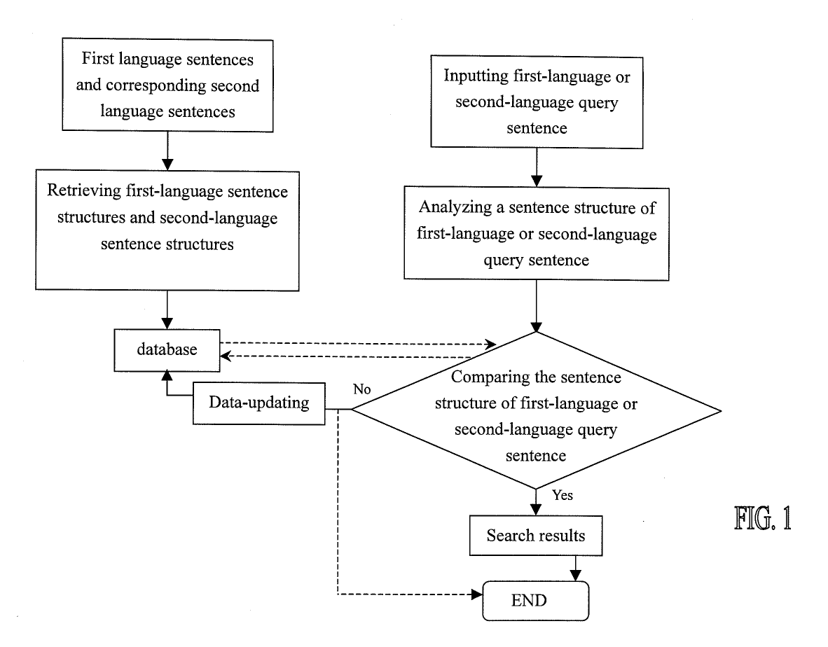

Referring initially to FIG. 1, a foreign-language learning database system in accordance with a first embodiment of the present invention is shown. In the illustrated embodiment, provided in the foreign-language learning system is a set of bilingual data which can be looked up by a user's native language. The first language sentences (e.g. native language) and the second language sentences (e.g. foreign language) are connected, according to their meanings, to form several strings of bilingual data.

Referring again to FIG. 1, a sematics analyzer (for example: “PASER™” software) is used to analyze the first language sentences and the second language sentences so that the first-language sentence structures and the second-language sentence structures are received. In an embodiment, a word segmentation system may not be required if one or both of the first language sentence and the second language sentence exist spaces among words.

Still referring to FIG. 1, the sentence structure of the first-language or second-language query sentence is automatically compared with the first-language sentence structures or the second-language sentence structures stored in the foreign-language learning database system to generate search results of matched sentences. In comparing operation, the search results of matched sentences may be a hundred percent matched or has a predetermined matching degree with the first-language sentence structures or the second-language sentence structures.

Accordingly, users can review the matched sentences of the translated texts in their native or desired language, and the matching degrees thereof. Advantageously, the foreign-language learning database system in accordance with a preferred embodiment of the present invention can provide the users to avoid using unfamiliar foreign language in reviewing the accuracy of the translated texts.

In the illustrated embodiment, the foreign-language learning database system is functioned to provide sentence-to-sentence translation. For example, when a Chinese query sentence [symbol] (meaning in English: I wrote a letter to you)) is input into the foreign-language learning database system, the sentence structure “Subject [symbol] (meaning in English: I))+Verb [symbol] (meaning in English: write))+First Object [symbol] (meaning in English: letter))+Preposition [symbol] (meaning in English: forward))+Second Object [symbol] (meaning in English: you))” is retrieved and compared with all of Chinese sentence structures stored in the database. In comparing operation, all Chinese sentence structures matched the structure “Subject+Verb+First Object+Preposition+Second Object” are generated and shown in Chinese for further review.

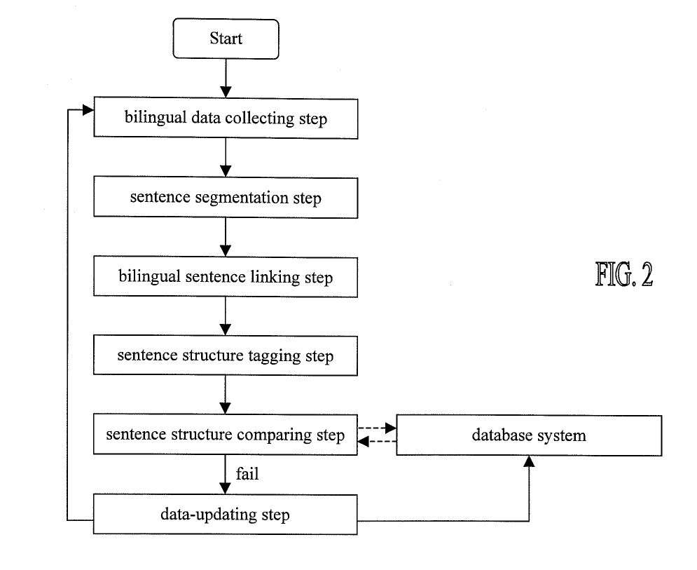

Turning now to FIG. 2, an establishing method of the system in accordance with a preferred embodiment of the present invention includes the steps of: bilingual data collecting step; sentence segmentation step; bilingual sentence linking step; sentence structure tagging step; and sentence structure comparing step. The establishing method of the system in accordance with the present invention further includes the steps of system testing and data updating.

With continued reference to FIG. 2, the establishing method of the system in accordance with the present invention will be exemplified as follows:

Bilingual data collecting step: Collecting bilingual texts which contains at least one source language structure (i.e. original language) corresponding to at least one target language structure (i.e. foreign, language). The bilingual texts are converted into digital computer files by character recognition software which may be available from “Newsoft™” software and “OmniPage™” software, for example. In an embodiment, if the bilingual texts are speech data, the bilingual texts are converted into digital computer files by a computer software tool.

Sentence segmentation step: Sentence segmentation software is used to separate the bilingual texts sentence by sentence according to symbols of Chinese full stops “∘” and English full stops “.”, for example. Accordingly, several separate sentences of the source language and the target language are generated.

Bilingual sentence linking step: The separate sentences of the source language and the target language are classified, and sentence structures thereof are analyzed by semantic analysis software in the following step. Sentence linking software is used to correspondingly link each source language sentence with at least one equivalent target language sentence so that each pair of the source language sentence and the equivalent target language sentence can be shown.

Sentence structure tagging step: Semantic analysis software, for example: “Parser™” software, is used to analyze each separate sentence structure of the source language and the target language. In an embodiment, the Chinese sentence [symbol] [symbol] (meaning in English: Mr. Lin married with Ms. Chen)” can be converted into the sentence structure [symbol] (meaning in English: Mr. Lin)” (subject)+ [symbol] (meaning in English: with)” (preposition)+ [symbol] (meaning in English: Ms. Chen)” (object)+ [symbol] (meaning in English: married)” (verb). Subsequently, the analyzed sentence structures can be tagged automatically.

Sentence structure comparing step: The sentence structures of the source language are compared with those previously stored in the database system to check the corresponding sentence of the target language. Users can review the target language if the sentence structure of the source language is matched. If the sentence structure comparing step fails, the database system can be operated in the data updating step.

Data updating step: The sentences of the source language and the target language are added to the database system if the sentence structure comparing step fails. New bilingual texts can be added to the database system by repeating the above steps.

The operation steps using a Chinese query sentence in the foreign-language learning database system in accordance with the present invention will be exemplified as follows:

Step 1. Inputting a Chinese query sentence [symbol] [symbol] [symbol] into the database system;

Step 2. Operating a sentence segmentation tool to separate the Chinese query sentence [symbol] [symbol] (meaning in English: Could you tell me how to get to the railway station?)” into a series of segments

[symbol]

[symbol]

[symbol]

Step 3. Operating a sematics analyzer (e.g. “PASER™” software) to analyze and tag the sentence structure of the Chinese query sentence as “Subject [symbol] (meaning in English: “you” addressed in polite form))+Auxiliary Verb [symbol] (meaning in English: could))+Negative [symbol] (meaning in English: not))+Auxiliary Verb [symbol] (meaning in English: could))+Verb [symbol] (meaning in English: tell))+Object [symbol] (meaning in English: me))+Adverb [symbol] (meaning in English: how))+Preposition [symbol] (meaning in English: to get to))+Object [symbol] (meaning in English: railway station))”;

Step 4. Comparing the sentence structure “Subject+Auxiliary Verb+Negative+Auxiliary Verb+Verb+Object+Adverb+Preposition+Object” with those stored in the database system to generate search results as follows:

First search result (identified as “4a”): “Subject [symbol] +Auxiliary Verb [symbol] +Negative [symbol] +Auxiliary Verb [symbol] +Verb [symbol] +Object [symbol] +Adverb [symbol] +Preposition [symbol] +Object [symbol] which has a matching degree of 100%;

Second search result (identified as “4b”): “Subject [symbol] (meaning in English: “you” addressed in polite form))+Auxiliary Verb [symbol] (meaning in English: could))+Negative [symbol] (meaning in English: not))+Auxiliary Verb [symbol] (meaning in English: could))+Verb [symbol] (meaning in English: tell))+Object [symbol] (meaning in English: me))+Adverb [symbol] (meaning in English: how))+Preposition [symbol] (meaning in English: to get to))+Object [symbol] (meaning in English: post office))” which has a matching degree of 90% due to the fact that the meaning of the second object of the sentence structure of this search result differs from that of the Chinese query sentence;

Third search result (identified as “4c”): “Subject [symbol] (meaning in English: “you” addressed in normal form))+Auxiliary Verb [symbol] (meaning in English: could))+Negative [symbol] (meaning in English: not))+Auxiliary Verb [symbol] (meaning in English: could))+Verb [symbol] (meaning in English: tell))+Object [symbol] (meaning in English: me))+Adverb [symbol] (meaning in English: how))+Preposition [symbol] (meaning in English: to get to))+Object [symbol] (meaning in English: hotel))” which has a matching degree of 80% due to the fact that the meanings of the subject and the second object of the sentence structure of this search result differ from those of the Chinese query sentence;

Fourth search result (identified as “4d”): “Subject [symbol] (meaning in English: “you” addressed in normal form))+Auxiliary Verb [symbol] (meaning in English: want))+Negative [symbol] (meaning in English: not))+Auxiliary Verb [symbol] (meaning in English: want))+Verb [symbol] (meaning in English: teach))+Object [symbol] (meaning in English: me))+Adverb [symbol] (meaning in English: “how” addressed in another form))+Preposition [symbol] (meaning in English: down))+Object [symbol] (meaning in English: basement))” which has a matching degree of 50% due to the fact that several portions of the sentence structure and the meanings of the terms reflected from this search result differ from those of the Chinese query sentence;

Fifth search result (identified as “4e”): “Subject [symbol] (meaning in English: “you” addressed in normal form))+Auxiliary Verb [symbol] (meaning in English: want))+Negative [symbol] (meaning in English: not))+Auxiliary Verb [symbol] (meaning in English: want))+Verb [symbol] (meaning in English: teach))+Object [symbol] (meaning in English: me))+Adverb [symbol] (meaning in English: “how” addressed in another form))+Preposition [symbol] (meaning in English: to go to))+Object [symbol] (meaning in English: his home))” which has a matching degree of 40% due to the fact that many portions of the sentence structure and the meanings reflected from this search result differ from those of the Chinese query sentence;

Step 5. Reviewing the first through fifth search results “4a” through “4e” in the source language with a predetermined matching degree to determine the desired target language sentence. In an embodiment, the search results may be skipped if the matching degree is lower than 60% to obtain the desired sentences of the search results as follows:

First search result “4a”: “Subject [symbol] +Auxiliary Verb [symbol] +Negative [symbol] +Auxiliary Verb [symbol] +Verb [symbol] +Object [symbol] +Adverb [symbol] Preposition [symbol] +Object [symbol] which has a matching degree of 100%;

Second search result (identified as “4b”): “Subject [symbol] (meaning in English: “you” addressed in polite form))+Auxiliary Verb [symbol] (meaning in English: could))+Negative [symbol] (meaning in English: not))+Auxiliary Verb [symbol] (meaning in English: could))+Verb [symbol] (meaning in English: tell))+Object [symbol] (meaning in English: me))+Adverb [symbol] (meaning in English: how))+Preposition [symbol] (meaning in English: to get to))+Object [symbol] (meaning in English: post office))” which has a matching degree of 90%;

Third search result (identified as “4c”): “Subject [symbol] (meaning in English: “you” addressed in normal form))+Auxiliary Verb [symbol] (meaning in English: could))+Negative [symbol] (meaning in English: not))+Auxiliary Verb [symbol] (meaning in English: could))+Verb [symbol] (meaning in English: tell))+Object [symbol] (meaning in English: me))+Adverb [symbol] (meaning in English: how))+Preposition [symbol] (meaning in English: to get to))+Object [symbol] (meaning in English: hotel))” which has a matching degree of 80%.

The meanings of the first through third search results “4a”, “4b” and “4c” shown in Chinese can be reviewed to match the exact expression of the Chinese query sentence, and to correspondingly generate the translated target language as follows:

Once the sentence structure “Subject [symbol] +Auxiliary Verb [symbol] +Negative [symbol] +Auxiliary Verb [symbol] +Verb [symbol] +Object [symbol] +Adverb [symbol] +Preposition [symbol] +Object [symbol] of the first search result with a matching degree of 100% is selected, the database system can generate the translated sentence (“Could you tell me how to get to the railway station?”) which is completely translated into the target language;

Once the sentence structure “Subject [symbol] +Auxiliary Verb [symbol] +Negative [symbol] +Auxiliary Verb [symbol] +Verb [symbol] +Object [symbol] +Adverb [symbol] +Preposition [symbol] +Object [symbol] of the second search result with a matching degree of 90% is selected, the database system can generate the translated sentence (“Could you tell me how to get to the post office?”) which is completely translated into the target language;

Once the sentence structure “Subject [symbol] +Auxiliary Verb [symbol] +Negative [symbol] +Auxiliary Verb [symbol] +Verb [symbol] +Object [symbol] +Adverb [symbol] +Preposition [symbol] +Object [symbol] of the second search result with a matching degree of 80% is selected, the database system can generate the translated sentence (“Could you tell me how to get to the hotel?”) which is completely translated into the target language.

Advantageously, users interactive with the database system of the present invention can operatively review the differences among the search results “4a”, “4b” and “4c” in the source language without the need of having the ability of translation with a very high degree of accuracy or having very specialized skills.

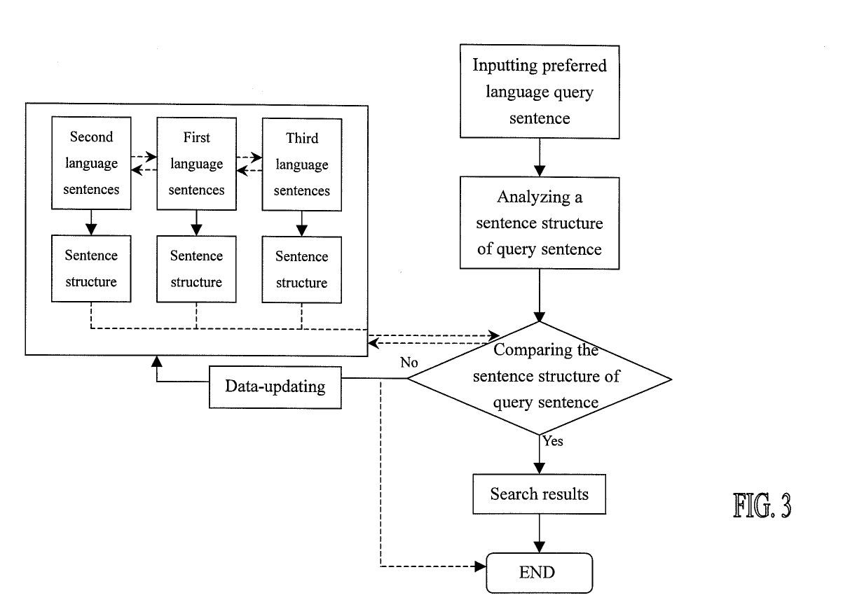

Turning now to FIG. 3, the foreign-language learning database system in accordance with a second embodiment of the present invention includes first language sentences, first-language sentence structures, second language sentences, second-language sentence structures, third language sentences and third-language sentence structures. Each of the first language sentences links at least one of the second language sentences or at least one of the third language sentences. The first language sentences, the second language sentences and the third language sentences are grouped in a first predetermined area, a second predetermined area and a third predetermined area of the database, respectively. The first-language sentence structures are retrieved from the first language sentences and classified according to their structures, and each of the first-language sentence structures links the corresponding first language sentence and the corresponding second language sentence. Correspondingly, the second-language sentence structures and the third-language sentence structures are retrieved from the second language sentences and the third language sentences, respectively; and classified according to their structures. Each of the second-language sentence structures or each of the third-language sentence structures links the corresponding second language sentence or the corresponding third language sentence.

With continued reference to FIG. 3, the foreign-language learning database system in accordance with the second embodiment of the present invention can be operated by inputting a query sentence expressed in the first, second or third language. Advantageously, the foreign-language learning database system can be arranged to provide multi-language learning function, and can be expanded to provide several different languages in translation practicing.

In translation practicing, the matched first language sentences of the search results are displayed in the first language, and are reviewed in the first language in determining at least one of the desired second language sentences or the desired third language sentences. Or, the matched second language sentences of the search results are displayed in the second language, and are reviewed in the second language in determining at least one of the desired first language sentences or the desired third language sentences. Or, the matched third language sentences of the search results are displayed in the third language, and are reviewed in the third language in determining at least one of the desired first language sentences or the desired second language sentences.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A foreign-language learning method, utilizing an original language to review texts of corresponding foreign languages, comprising the steps of:
providing first language sentences and second language sentences in a database, each of the first language sentences linking at least one second language sentence;
analyzing and retrieving first-language sentence structures from the first language sentences and second-language sentence structures from the second language sentences, each of the first-language sentence structures linking the corresponding first language sentence and each of the second-language sentence structures linking the corresponding second language sentence;
inputting a first-language or second-language query sentence into the database;
retrieving a sentence structure from the first-language or second-language query sentence;
comparing the sentence structure of the first-language or second-language query sentence with the first-language sentence or second-language sentence structures so as to generate at least one or a set of matched sentences, and displaying the matched first or second language sentences; and
reviewing the matched first language sentences displayed in the first language for determining the desired second language sentence, or reviewing the matched second language sentences displayed in the second language for determining the desired first language sentence.

2. The method as defined in claim 1, wherein the first language is performed in Chinese and the second language is performed in English.

3. The method as defined in claim 1, wherein the matched sentences are provided with a matching degree.

4. A foreign-language learning database system, utilizing an original language to review texts of corresponding foreign languages, comprising:
a plurality of first language sentences grouped in a first predetermined area;
a plurality of first-language sentence structures retrieved from the first language sentences and classified according to their structures, each of the first-language sentence structures linking the corresponding first language sentence;
a plurality of second language sentences grouped in a second predetermined area, each of the first language sentences linking at least one of the second language sentences; and
a plurality of second-language sentence structures retrieved from the second language sentences and classified according to their structures, each of the second-language sentence structures linking the corresponding second language sentence;
wherein when a first-language or second-language query sentence is input into the database, a sentence structure is retrieved from the first-language or second-language query sentence to compare with the first-language sentence or second-language sentence structures so as to generate at least one or a set of matched sentences; and
wherein the matched first language sentences are displayed in the first language, and are reviewed in the first language in determining at least one of the desired second language sentences, or the matched second language sentences are displayed in the second language, and are reviewed in the second language in determining at least one of the desired first language sentences.

5. The system as defined in claim 4, wherein the first language is Chinese and the second language is English.

6. The system as defined in claim 4, wherein the matched sentences are provided with a matching degree.

7. A foreign-language learning database system, utilizing an original language to review texts of corresponding foreign languages, comprising:
a plurality of first language sentences grouped in a first predetermined area;
a plurality of first-language sentence structures retrieved from the first language sentences and classified according to their structures, each of the first-language sentence structures linking the corresponding first language sentence;
a plurality of second language sentences grouped in a second predetermined area, each of the first language sentences linking at least one of the second language sentences;
a plurality of second-language sentence structures retrieved from the second language sentences and classified according to their structures, each of the second-language sentence structures linking the corresponding second language sentence;
a plurality of third language sentences grouped in a third predetermined area, each of the first language sentences linking at least one of the third language sentences; and
a plurality of third-language sentence structures retrieved from the third language sentences and classified according to their structures, each of the third-language sentence structures linking the corresponding third language sentence;
wherein when a query sentence is input into the database, a sentence structure is retrieved from the query sentence to compare with the first-language sentence structures, the second-language sentence structures or the third-language sentence structures so as to generate at least one or a set of matched sentences; and
wherein the matched first language sentences are displayed in the first language, and are reviewed in the first language in determining at least one of the desired second language sentences or the desired third language sentences; or the matched second language sentences are displayed in the second language, and are reviewed in the second language in determining at least one of the desired first language sentences or the desired third language sentences; or the matched third language sentences are displayed in the third language, and are reviewed in the third language in determining at least one of the desired first language sentences or the desired second language sentences.

8. The system as defined in claim 7, wherein the matched sentences are provided with a matching degree.
